(19) United States
(12) Patent Application Publication
(10) Pub. No.: US 2015/0139640 A1
(43) Pub. Date: May 21, 2015

(54) OPTICAL MONITORING USING OPTICAL FREQUENCY COMBS

(71) Applicant: Alcatel-Lucent USA Inc., Murray Hill, NJ (US)

(72) Inventors: Robert M. Jopson, Rumson, NJ (US); Alan H. Gnauck, Middletown, NJ (US)

(73) Assignee: ALCATEL-LUCENT USA INC., Murray Hill, NJ (US)

(21) Appl. No.: 14/083,739

(22) Filed: Nov. 19, 2013

(51) Int. Cl. H04B 10/079; H04J 14/06; H04J 14/02

(52) U.S. Cl. CPC H04B 10/0795; H04J 14/02; H04J 14/06
USPC 398/34

(57) ABSTRACT

In one embodiment, an optical performance monitor (OPM) is configured to monitor a received optical wavelength-division-multiplexed (WDM) signal generated by modulating spectral lines of an optical frequency comb. The OPM is further configured to mix the received optical WDM signal with light of another optical frequency comb having a slightly different tooth spacing to generate a set of beat signals at frequencies representing frequency differences between the spectral lines (such as, at the carrier frequencies) of the optical WDM signal and the spectral lines of said another optical frequency comb. The OPM can further be configured to measure one or more parameters of the received optical WDM signal based on the characteristics of the generated beat signals and provide the resulting OPM data to a system controller for maintaining favorable signal-transport conditions within the system.

### BACKGROUND

1. Field

The present disclosure relates to optical-monitoring apparatus and methods.

2. Description of the Related Art

This section introduces aspects that may help facilitate a better understanding of the invention(s). Accordingly, the statements of this section are to be read in this light and are not to be understood as admissions about what is in the prior art or what is not in the prior art.

Optical performance monitoring can be used, e.g., for managing a high-capacity dense wavelength-division-multiplexing (DWDM) optical transport system. Optical performance monitoring is typically directed at assessing the quality of optical transport channels by measuring their pertinent characteristics without directly looking at the payloads carried by the corresponding modulated optical carriers. The obtained performance-monitoring data can be used, e.g., to ensure correct switching in reconfigurable optical add-drop multiplexers and appropriate gain(s) in optical amplifiers, and to provide system alarms and error warnings. A system component used for these purposes is typically referred to as an optical performance monitor (OPM) or an optical channel monitor (OCM).

### SUMMARY OF SOME SPECIFIC EMBODIMENTS

According to one embodiment, provided is an OPM configured to monitor a received optical wavelength-division-multiplexed (WDM) signal generated by modulating spectral lines of an optical frequency comb. The OPM is configured to mix the received optical WDM signal with light of another optical frequency comb having a slightly different tooth spacing to generate a set of beat signals at frequencies representing frequency differences between the spectral lines (such as, spectral lines at the carrier frequencies) of the optical WDM signal and the spectral lines of said another optical frequency comb. The OPM may be further configured to (i) measure one or more parameters of the received optical WDM signal based on the characteristics of the generated beat signals and (ii) provide the resulting OPM data to a system controller, e.g., to enable the latter to appropriately adjust operating parameters of various system components to maintain favorable signal-transport conditions within the system.

According to an alternative embodiment, provided is an apparatus comprising: a first optical-frequency-comb source configured to generate a first optical frequency comb having a first tooth spacing; a first optical signal combiner configured to optically mix the first optical frequency comb and a first optical WDM signal to generate a first mixed optical signal, wherein nominal spacing between carrier frequencies of the first optical WDM signal is different from the first tooth spacing; and a first signal-processing circuit configured to measure one or more beat signals corresponding to the first mixed optical signal to determine one or more parameters of the first optical WDM signal, wherein each of said one or more beat signals has a respective beat frequency corresponding to a frequency difference between a respective tooth from the first optical frequency comb and a respective spectral line of the first optical WDM signal.

According to another embodiment, provided is an optical-signal-monitoring method comprising the steps of: generating a first optical frequency comb using a first optical-frequency-comb source, wherein the first optical frequency comb has a first tooth spacing; optically mixing the first optical frequency comb and a first optical WDM signal in an optical signal combiner to generate a first mixed optical signal, wherein nominal spacing between carrier frequencies of the first optical WDM signal is different from the first tooth spacing; and measuring one or more beat signals corresponding to the first mixed optical signal to determine one or more parameters of the first optical WDM signal, wherein each of said one or more beat signals has a respective beat frequency corresponding to a frequency difference between a respective tooth from the first optical frequency comb and a respective spectral line of the first optical WDM signal.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of an optical transport system according to an embodiment of the disclosure;

FIG. 2 shows a block diagram of an optical performance monitor that can be used in the optical transport system of FIG. 1 according to an embodiment of the disclosure; and

FIGS. 3A-3C graphically illustrate example signals in the optical performance monitor of FIG. 2 according to an embodiment of the disclosure.

### DETAILED DESCRIPTION

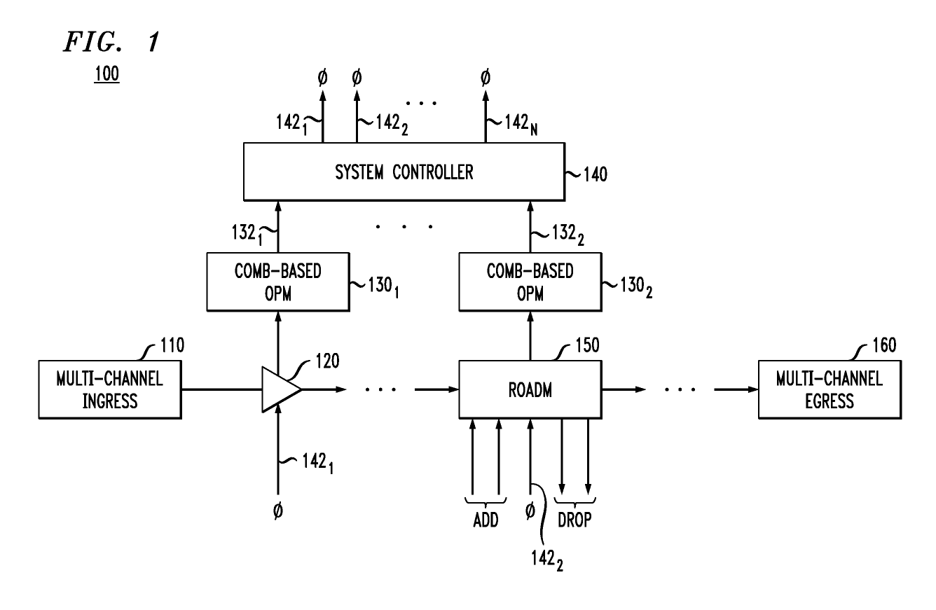

In at least some embodiments disclosed herein, various optical fiber transport systems, e.g., system 100 of FIG. 1, may be configured to optically route an optical super-channel having a plurality of optical frequency sub-channels. The plurality of optical frequency sub-channels may be separately data-modulated and routed together between each corresponding pair of source and destination optical network nodes. Such an optical fiber transport system may be contrasted with a conventional WDM-type optical communication system in that, in the latter, a single data-modulated optical frequency carrier may be routed between a pair of source and destination optical network nodes, and different data-modulated optical frequency carriers may correspond to different respective pairs of source and destination optical network nodes.

Herein, an optical transmitter of such an optical super-channel may be referred to as a generator of an optical frequency comb (OFC), e.g., because such an optical transmitter may be configured to generate a comb of closely spaced, separately data-modulated optical frequency carriers. In some OFC embodiments, the separately data-modulated optical frequency carriers may form overlapping frequency bands, such as similar to those resulting from an optical orthogonal-frequency-division-multiplexing (OFDM) modulation scheme. Alternatively, the separately data-modulated optical frequency carriers may be in closely spaced but non-overlapping frequency bands. For example, the adjacent ones of the data-modulated optical carriers may not be separated by optical guard bands or may be only separated by relatively narrow guard bands, e.g., guard bands that are narrower than about 10% of the width of individual data-modulated optical frequency carriers. In some embodiments, such an optical transmitter may generate the individual data-modulated optical frequency carriers using an optical frequency comb characterized by a relatively high carrier-frequency stability, e.g., to enable the closeness or overlap of the adjacent ones of the data-modulated optical frequency carriers without significantly detrimentally affecting the ability of the remote optical receiver to demodulate and decode the corresponding received optical signal(s).

In some embodiments, a coherent optical receiver of an optical super-channel may include a local optical source that also generates an optical frequency comb. In particular, such a local optical source may be configured to generate an optical frequency comb of optical frequencies for being mixed with the corresponding ones of the data-modulated optical frequency carriers in the received optical signal, which has arrived via an optical fiber from the corresponding optical transmitter. Such a local optical source may be configured to generate the optical frequency comb such that the optical frequencies thereof have about the same spacing and values as the optical frequency carriers that have been used by the corresponding optical transmitter, e.g., in the above-mentioned optical OFDM modulation scheme or to generate the closely spaced but non-overlapping frequency bands.

FIG. 1 shows a block diagram of an optical transport system 100 according to an embodiment of the disclosure. Optical transport system 100 is configured to transmit optical wavelength-division-multiplexed (WDM) signals between a multi-channel ingress node 110 and a multi-channel egress node 160. Herein, the term “WDM” should be construed to cover conventional WDM, DWDM, OFDM, and optical super-channel embodiments. The optical transport network that optically connects nodes 110 and 160 includes one or more spans of optical transmission fiber and may include one or more intermediate nodes and/or other pertinent network components connected by the span(s). FIG. 1 illustratively shows only some of the spans, an optical-amplifier-based signal repeater 120, and a reconfigurable optical add-drop multiplexer (ROADM) 150. One of ordinary skill in the art will understand that the optical transport network may also include various other optical network components (not explicitly shown in FIG. 1) between nodes 110 and 160.

An optical transmitter in optical transport system 100, such as an optical transmitter in ingress node 110 or an optical transmitter coupled to the add ports of ROADM 150 (neither of which transmitters is explicitly shown in FIG. 1), may be configured to generate optical WDM signals by modulating optical carriers generated by one or more optical sources, e.g., one or more OFC sources therein. An optical receiver in optical transport system 100, such as an optical receiver in egress node 160 or an optical receiver coupled to the drop ports of ROADM 150 (neither of which receivers is explicitly shown in FIG. 1), may be configured to coherently detect the received optical WDM signals using a local-oscillator signal generated by one or more coherent optical sources, e.g., one or more OFC sources therein. In some embodiments, the optical frequency combs generated by different receiver and transmitter OFC sources in optical transport system 100 can be spectrally aligned and/or phase-locked with respect to one another in a relatively precise manner. In one embodiment, such spectral alignment and phase locking can be achieved using the OFC-source cloning and phase-locking techniques disclosed, e.g., in U.S. Pat. Nos. 7,123,402 and 7,706,536, both of which are incorporated herein by reference in their entirety. Optical WDM transmitters and receivers configured to operate using optical frequency combs generated by OFC sources are disclosed, e.g., in U.S. Pat. No. 7,561,807 and U.S. Patent Application Publication No. 2006/0263096, both of which are incorporated herein by reference in their entirety.

An optical frequency comb has a spectrum comprising a series of discrete, relatively narrow, equally spaced spectral lines (also referred to as “comb teeth”). The frequency spectrum of an optical frequency comb can be approximately described using Eq. (1):

fₙ=fᵣ+nΔf (1)

where fₙ is the frequency of the n-th spectral line (tooth) in the comb; n is an integer; Δf is the tooth spacing in the comb; and fᵣ is the frequency offset or the reference frequency of the comb. Herein, two optical frequency combs are referred to as “cloned” optical frequency combs if they have the same respective values of both frequency offset fᵣ and tooth spacing Δf. Two optical frequency combs are referred to as “shifted” optical frequency combs if they have the same value of tooth spacing Δf but different respective values of frequency offset fᵣ. Two optical frequency combs are referred to as “scaled” optical frequency combs if they have the same value of frequency offset fᵣ but different respective values of tooth spacing Δf. Two optical frequency combs are referred to as “shifted and scaled” optical frequency combs if they have different respective values of both frequency offset fᵣ and tooth spacing Δf.

A detailed description of how to generate different types of optical frequency combs can be found, e.g., in the above-cited U.S. Pat. Nos. 7,123,402, 7,561,807, and 7,706,536 and U.S. Patent Application Publication No. 2006/0263096. Additional description can also be found in the following publications: (1) T. Udem, J. Reichert, T. W. Hansch, and M. Kourogi, “Accuracy of Optical Frequency Comb Generators and Optical Frequency Interval Divider Chains,” OPTICS LETTERS, 1998, Vol. 23, No. 17, pp. 1387-1389; (2) Philipp Kubina, Peter Adel, Florian Adler, Gesine Grosche, Theodor W. Hansch, Ronald Holzwarth, Alfred Leitenstorfer, Burghard Lipphardt, and Harald Schnatz, “Long Term Comparison of Two Fiber Based Frequency Comb Systems,” OPTICS EXPRESS, 2005, Vol. 13, No. 3, pp. 904-909; (3) Bill P. P. Kuo, Evgeny Myslivets, Nikola Alic, and Stojan Radic, “Wavelength Multicasting via Frequency Comb Generation in a Bandwidth-Enhanced Fiber Optical Parametric Mixer,” JOURNAL OF LIGHTWAVE TECHNOLOGY, 2011, Vol. 29, No. 23, pp. 3515-3522; and (4) Evgeny Myslivets, Bill P. P. Kuo, Nikola Alic, and Stojan Radic, “Generation of Wideband Frequency Combs by Continuous-Wave Seeding of Multistage Mixers with Synthesized Dispersion,” OPTICS EXPRESS, 2012, Vol. 20, No. 3, pp. 3331-3344, all of which publications are incorporated herein by reference in their entirety.

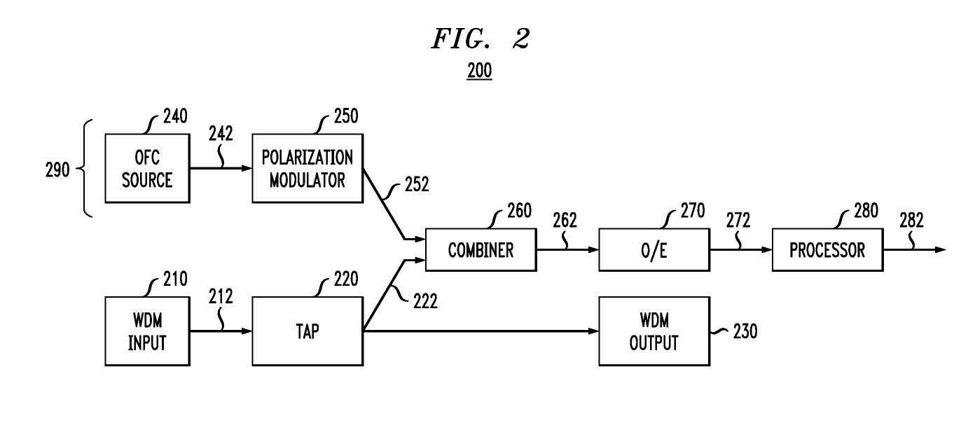

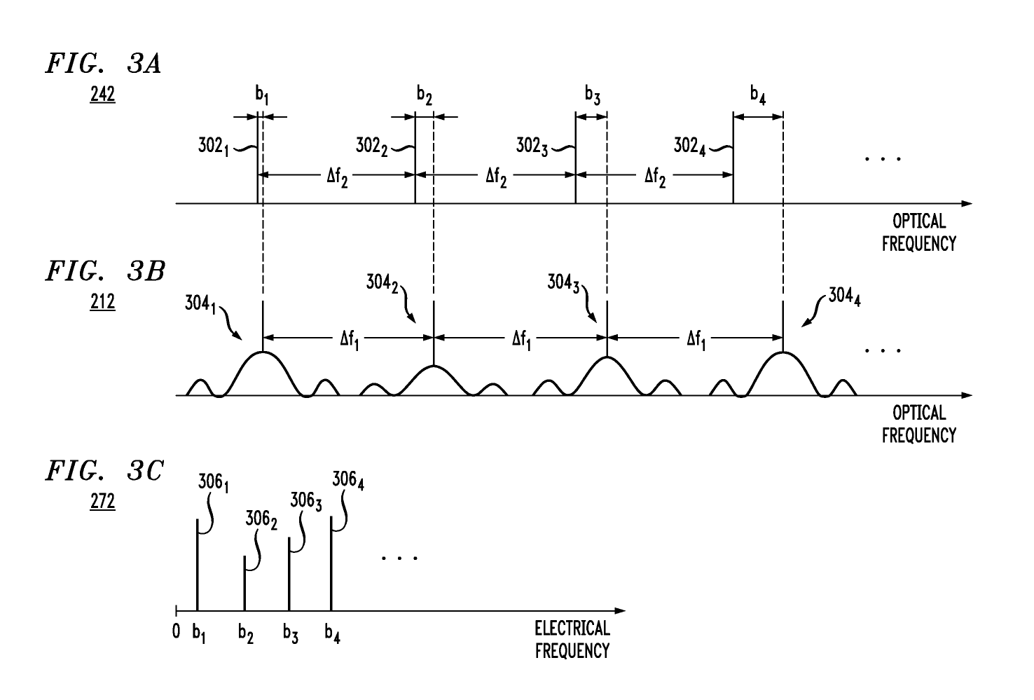

At various points within the optical transport network between nodes 110 and 160, optical WDM signals are tapped off and measured using a plurality of optical performance monitors (OPMs), such as an OPM 130, optical channel monitors (OCMs), and/or various other appropriately configured pieces of network-monitoring equipment. For illustration purposes, only two OPMs, labeled 130₁ and 130₂, are shown in FIG. 1. OPM 130₁ is configured to measure optical WDM signals at signal repeater 120. OPM 130₂ is similarly configured to measure optical WDM signals at ROADM 150. In an example embodiment, an OPM 130 can be configured to measure, e.g., the following signal parameters: (i) presence or absence of a modulated or non-modulated optical carrier or WDM-signal component; (ii) optical power of individual optical carriers or WDM-signal components; (iii) optical power per polarization; (iv) wavelengths of individual optical carriers; and (v) optical signal-to-noise ratio (OSNR). A more detailed description of example embodiments of OPM 130 is given below in reference to FIGS. 2 and 3A-3C.

The measurement results generated by OPMs 130₁ and 130₂ are supplied, e.g., via service channels 132₁ and 132₂, to a system controller 140. System controller 140 may further be configured to receive channel-monitoring data from other pieces of network-monitoring equipment variously disposed throughout optical transport system 100. In response to the received OPM and channel-monitoring data, system controller 140 may generate control signals 142₁-142_{N}, which may be directed to various respective network components. For example, control signal 142₁ is shown in FIG. 1 as being applied to signal repeater 120 to cause the signal repeater to set or change the optical gain(s) therein. Control signal 142₂ is shown in FIG. 1 as being applied to ROADM 150 to cause the ROADM to set or change its operating parameters. Control signals 142₃-142_{N} may similarly be directed to these and/or other network components (not explicitly shown in FIG. 1) to cause those network components to set or change their operating parameters, with the general purpose of achieving and/or maintaining favorable (e.g., nearly optimal) optical-signal-transport conditions in system 100.

FIG. 2 shows a block diagram of an OPM 200 that can be used as an OPM 130 (FIG. 1) according to an embodiment of the disclosure.

OPM 200 has an optical tap 220 located between a WDM input port 210 and a WDM output port 230. Optical tap 220 operates to tap off a relatively small portion (e.g., about 1%) of the optical power of an optical WDM signal 212 received at WDM input port 210 and direct a resulting tapped-off optical signal 222 to an optical signal combiner 260. In some embodiments, optical signal 222 is an attenuated copy of optical WDM signal 212. In some other embodiments, prior to being applied to optical signal combiner 260, optical signal 222 may be amplified in an optical amplifier and/or filtered by an optical filter (not explicitly shown in FIG. 2).

Optical signal combiner 260 is part of an optical intradyne detector 290, which also includes an OFC source 240, a polarization modulator 250, an optical-to-electrical (O/E) converter 270, and a signal processor (e.g., a digital signal processor, DSP) 280. Optical signal combiner 260 operates to optically mix optical signal 222 received from optical tap 220 and an optical frequency comb 252 received from OFC source 240 via polarization modulator 250 to generate a mixed or interference optical signal 262.

OFC source 240 is configured to generate an optical frequency comb 242 that is a scaled or a shifted and scaled optical frequency comb with respect to the optical frequency comb used in the generation of optical WDM signal 212. Polarization modulator 250 transforms optical frequency comb 242 into optical frequency comb 252 by changing the polarization of the former in a predetermined time-dependent manner. For example, one possible polarization-modulation pattern imposed by polarization modulator 250 may cause the polarization of optical frequency comb 252 to alternate between two orthogonal states of polarization (e.g., the X polarization and the Y polarization, where X and Y are the coordinate axes orthogonal to the longitudinal axis of the optical fiber) in a stepwise manner, with the state of polarization being held constant for a fixed amount of time between the polarization transitions. Other suitable polarization-modulation patterns can also be used.

In one embodiment, one purpose of polarization changes imposed by polarization modulator 250 may be to independently probe the X and Y polarization components of optical WDM signal 212. For example, when optical frequency comb 252 has the X polarization, optical signal 262 is indicative of the X polarization of optical WDM signal 212. Similarly, when optical frequency comb 252 has the Y polarization, optical signal 262 is indicative of the Y polarization of optical WDM signal 212.

O/E converter 270 operates to convert optical signal 262 into a corresponding electrical signal 272. The photo-detectors used in O/E converter 270 in effect serve as a low-pass filter, which causes electrical signal 272 to contain various beat frequencies corresponding to comb-line pairs from optical signal 222 and optical frequency comb 252, respectively. For example, when OFC source 240 is configured to generate optical frequency comb 242 as a shifted and scaled optical frequency comb relative to the optical frequency comb used in the generation of optical WDM signal 212, electrical signal 272 contains the following beat frequencies:

bₙ=|fᵣ₁−fᵣ₂+n(Δf₁−Δf₂)| (2)

where bₙ is the n-th beat frequency; n is an integer; Δf₁ and fᵣ₁ are the tooth spacing and the frequency offset, respectively, in the optical frequency comb used in the generation of optical WDM signal 212; and Δf₂ and fᵣ₂ are the tooth spacing and the frequency offset, respectively, in optical frequency comb 242. In one embodiment, |fᵣ₁−fᵣ₂|<Δf₁, Δf₂. A person of ordinary skill in the art will recognize that additional beat frequencies may also be present in electrical signal 272. However, these additional beat frequencies can be removed by appropriate choice of fᵣ₁, fᵣ₂, Δf₁, and Δf₂, together with appropriate filtering implemented in signal processor 280.

When OFC source 240 is configured to generate optical frequency comb 242 as a scaled optical frequency comb with respect to the optical frequency comb used in the generation of optical WDM signal 212, electrical signal 272 contains beat frequencies bₙ that can be described by Eq. (2), wherein |fᵣ₁−fᵣ₂|=0.

Signal processor 280 is configured to process electrical signal 272 to measure some or all of the above-mentioned parameters of optical WDM signal 212. In an example embodiment, the processing performed in signal processor 280 may include but is not limited to: (i) analog-to-digital conversion; (ii) Fourier transformation; (iii) filtering; and (iv) averaging. Signal processor 280 is configured to output the measurement results via an output signal 282, which can then be transmitted, via a service channel 132, to system controller 140 (see FIG. 1).

In one embodiment, polarization modulator 250 can be omitted, while optical signal combiner 260 is replaced by a conventional 90-degree optical hybrid. In this embodiment, each of signals 262 and 272 becomes a signal multiplex comprising four respective signals, e.g., I-X, Q-X, I-Y, and Q-Y, where X and Y denote the polarization, and I and Q denote the in-phase and quadrature signal components, respectively. Example optical hybrids that can be used in this embodiment of OPM 200 are disclosed, e.g., in U.S. Patent Application Publication Nos. 2007/0297806 and 2011/0038631, both of which are incorporated herein by reference in their entirety.

FIGS. 3A-3C graphically illustrate example signals 212, 242, and 272 (FIG. 2) according to an embodiment of the disclosure. More specifically, FIG. 3A shows a fragment of the spectrum of optical frequency comb 242. FIG. 3B shows a fragment of the spectrum of optical WDM signal 212. FIG. 3C shows a fragment of the spectrum of electrical signal 272. The spectra shown in FIGS. 3A and 3B have the same (common) frequency scale. The spectrum shown in FIG. 3C has an expanded frequency scale compared to that in FIGS. 3A and 3B.

Referring to FIG. 3A, the spectral fragment of optical frequency comb 242 shown in the figure has four comb teeth 302₁-302₄. One of ordinary skill in the art will understand that the omitted (not-shown) portion of the spectrum may have one or more additional comb teeth that are similar to comb teeth 302₁-302₄. The spectral separation between the comb teeth is Δf₂. Comb teeth 302₁-302₄ have substantially the same intensity, as indicated in FIG. 3A by their approximately equal heights.

Referring to FIG. 3B, the spectral fragment of optical WDM signal 212 shown in the figure has four WDM components 304₁-304₄. One of ordinary skill in the art will understand that the omitted (not-shown) portion of the spectrum may have additional WDM components that are similar to WDM components 304₁-304₄. Each of WDM components 304₁-304₄ has (i) a residual carrier, appearing as a thin solid line at the respective carrier frequency, and (ii) modulation sidebands at both sides of the residual carrier. The spectral separation between the residual carriers is Δf₁, where Δf₁>Δf₂. In an alternative embodiment, Δf₁ can be smaller than Δf₂. WDM components 304₁-304₄ have different intensities, as indicated in FIG. 3B by different respective heights of the residual carriers and areas under the sidebands. The different intensities of WDM components 304₁-304₄ may be due to, e.g., different respective propagation paths in the network and/or wavelength-dependent response of some of the network components in optical transport system 100 (FIG. 1).

Referring to FIG. 3C, the spectral fragment of electrical signal 272 shown in the figure has four spectral components (beat signals) 306₁-306₄ located at frequencies b₁-b₄, respectively. For clarity, FIG. 3C does not explicitly show the spectrally broad components arising from the beating of the modulation sidebands of WDM components 304₁-304₄ against comb teeth 302₁-302₄. One of ordinary skill in the art will further recognize that the omitted (not-shown) portion of the spectrum may have additional spectral components that are similar to spectral components 306₁-306₄. Spectral components 306₁-306₄ have different respective intensities, which can be used, e.g., to quantify the intensities of WDM components 304₁-304₄ (FIG. 3B) in optical WDM signal 212. The values of b₁-b₄ can be used, e.g., to quantify the parameters of (such as the carrier frequencies in) the optical frequency comb used for the generation of optical WDM signal 212 in optical transport system 100 (also see Eq. (2)). Polarization-specific parameters of optical WDM signal 212 can be measured, e.g., by separately processing the spectra of FIG. 3C corresponding to different polarization states of polarization modulator 250. OSNR characteristics of optical WDM signal 212 can be measured, e.g., by analyzing the time dependence of spectral components 306₁-306₄. Other suitable types of signal processing can further be applied to the spectrum shown in FIG. 3C to measure other pertinent characteristics of optical WDM signal 212.

A person of ordinary skill in the art will further recognize that, in some embodiments, relatively narrow spectral lines other than the lines representing the carrier frequencies can be naturally present or artificially inserted into the modulation sidebands of WDM components 304₁-304₄. In such embodiments, electrical signal 272 will contain further relatively narrow spectral lines in addition to spectral components 306₁-306₄ (FIG. 3C). These further spectral lines can be used instead of or in addition to spectral components 306₁-306₄ for monitoring the characteristics of optical WDM signal 212.

In some embodiments, the measurable range of the deviation of a carrier frequency from the corresponding nominal value maybe limited to the values that are smaller than about one half of the spacing between spectral components 306₁-306₄.

Although various embodiments of OPMs 130 and 200 have been described above in reference to monitoring optical WDM signals that are produced by modulating with data the spectral lines (teeth) of optical frequency combs generated by respective OFC sources, embodiments of the invention are not so limited. For example, in some embodiments, an OPM, such as OPM 130 (FIG. 1) or 200 (FIG. 2), can similarly be configured to monitor an optical WDM signal that has been produced by modulating with data a set of optical carriers, wherein each optical carrier has been generated by a respective individual laser. Each of such individual lasers may be configured to output light of a different respective optical frequency selected from a predetermined frequency grid, e.g., specified in the ITU-T G.694.2 Standard (“WDM applications: CWDM wavelength grid”) or the ITU-T G.694.1 Standard (“Spectral grids for WDM applications: DWDM frequency grid”).

According to an embodiment disclosed above in reference to FIGS. 1-3, provided is an optical transport system (e.g., 100, FIG. 1) for transporting optical WDM signals, the optical transport system comprising: a first optical-frequency-comb source (e.g., 240 and 250, FIG. 2) configured to generate a first optical frequency comb (e.g., 252, FIG. 2) having a first tooth spacing; a first optical signal combiner (e.g., 260, FIG. 2) configured to optically mix the first optical frequency comb and a first optical WDM signal (e.g., 222, FIG. 2) to generate a first mixed optical signal (e.g., 262, FIG. 2), wherein nominal spacing between carrier frequencies of the first optical WDM signal is different from the first tooth spacing; and a first signal-processing circuit (e.g., 270 and 280, FIG. 2) configured to measure one or more beat signals (e.g., 306₁-306₄, FIG. 3C) corresponding to the first mixed optical signal to determine one or more parameters of the first optical WDM signal, wherein each of said one or more beat signals has a respective beat frequency (e.g., b₁-b₄, FIG. 3C) corresponding to a frequency difference between a respective tooth from the first optical frequency comb and a respective spectral line of the first optical WDM signal.

In some embodiments of the above optical transport system, the first optical WDM signal has been generated using a second optical frequency comb having a second tooth spacing different from the first tooth spacing.

In some embodiments of any of the above optical transport systems, the respective spectral line is a spectral line representing a respective carrier frequency of the first optical WDM signal.

In some embodiments of any of the above optical transport systems, the respective spectral line is a spectral line located in a modulation sideband of a respective (possibly suppressed) carrier frequency of the first optical WDM signal.

In some embodiments of any of the above optical transport systems, the one or more parameters of the first optical WDM signal determined by the first signal processing circuit include one or more of: (i) presence or absence of a predetermined optical carrier; (ii) optical power of an individual modulated or non-modulated optical carrier; (iii) optical power per polarization of an individual modulated or non-modulated optical carrier; (iv) carrier frequency of an individual optical carrier; and (v) optical signal-to-noise ratio of an individual modulated or non-modulated optical carrier.

In some embodiments of any of the above optical transport systems, the first optical-frequency-comb source comprises a polarization modulator (e.g., 250, FIG. 2) configured to controllably change polarization of the first optical frequency comb.

In some embodiments of any of the above optical transport systems, the polarization modulator is configured to cause the polarization of the first optical frequency comb to alternate between a first (e.g., X) polarization and a second (e.g., Y) polarization orthogonal to the first polarization.

In some embodiments of any of the above optical transport systems, the first optical signal combiner comprises a 90-degree optical hybrid.

In some embodiments of any of the above optical transport systems, the first signal-processing circuit comprises: an optical-to-electrical converter (e.g., 270, FIG. 2) configured to convert the first mixed optical signal into a corresponding electrical signal (e.g., 272, FIG. 2); and a signal processor (e.g., 280, FIG. 2) configured to transform (e.g., apply a Fourier transform to) said corresponding electrical signal to generate said one or more spectral components.

In some embodiments of any of the above optical transport systems, the optical-to-electrical converter is configured to operate as a low-pass filter.

In some embodiments of any of the above optical transport systems, the signal processor is further configured to perform one or more of the following: (i) analog-to-digital conversion of the corresponding electrical signal; (ii) Fourier transformation of a digital form of the corresponding electrical signal; (iii) digital filtering of a digital form of the corresponding electrical signal; and (iv) time averaging of a digital form of the corresponding electrical signal.

In some embodiments of any of the above optical transport systems, the optical transport system further comprises an optical transmitter (e.g., at 110, FIG. 1) configured to generate the first optical WDM signal by modulating with data one or more teeth of a second optical frequency comb different from the first optical frequency comb.

In some embodiments of any of the above optical transport systems, the optical transport system further comprises an optical transmitter (e.g., at 110, FIG. 1) configured to generate the first optical WDM signal by modulating with data a plurality of optical carriers generated by a corresponding plurality of lasers.

In some embodiments of any of the above optical transport systems, the optical transport system further comprises a controller (e.g., 140, FIG. 1), wherein, in response to the one or more parameters of the first optical WDM signal determined by the first signal-processing circuit, the controller is configured to cause a component (e.g., 120, 150, FIG. 1) of the apparatus to change one or more of component's operating parameters.

In some embodiments of any of the above optical transport systems, the component is an optical-amplifier-based signal repeater (e.g., 120, FIG. 1); and the one or more of the component's operating parameters comprises an optical gain therein.

In some embodiments of any of the above optical transport systems, the component is a ROADM (e.g., 150, FIG. 1).

In some embodiments of any of the above optical transport systems, the optical transport system further comprises a second optical-frequency-comb source (e.g., 240 and 250 of FIG. 2 at 130₂ of FIG. 1) configured to generate a second optical frequency comb (e.g., 252, FIG. 2) having a second tooth spacing different from the first tooth spacing and the nominal spacing between carrier frequencies of the first optical WDM signal; a second optical signal combiner (e.g., 260 of FIG. 2 at 130₂ of FIG. 1) configured to optically mix the second optical frequency comb and a second optical WDM signal (e.g., 222 of FIG. 2 at 130₂ of FIG. 1) to generate a second mixed optical signal (e.g., 262 of FIG. 2 at 130₂ of FIG. 1); and a second signal-processing circuit (e.g., 270 and 280 of FIG. 2 at 130₂ of FIG. 1) configured to measure one or more beat signals (e.g., 306₁-306₄, FIG. 3C) corresponding to the second mixed optical signal to determine one or more parameters of the second optical WDM signal, wherein each of said one or more beat signals has a respective beat frequency (e.g., b₁-b₄, FIG. 3C) corresponding to a frequency difference between a respective tooth from the second optical frequency comb and a respective carrier frequency of the second optical WDM signal. In some of the embodiments, the second optical WDM signal may have the same nominal spacing between its carrier frequencies as that in the first optical WDM signal.

In some embodiments of any of the above optical transport systems, the optical transport system further comprises a controller (e.g., 140, FIG. 1), wherein, in response to the one or more parameters of the first optical WDM signal determined by the first signal-processing circuit and to the one or more parameters of the second optical WDM signal determined by the second signal-processing circuit, the controller is configured to cause (i) a first component (e.g., 120, FIG. 1) of the apparatus to change one or more of first component's operating parameters and (ii) a second component (e.g., 150, FIG. 1) of the apparatus to change one or more of second component's operating parameters.

In some embodiments of any of the above optical transport systems, the first component is an optical-amplifier-based signal repeater (e.g., 120, FIG. 1); and the second component is a ROADM (e.g., 150, FIG. 1).

In some embodiments of any of the above optical transport systems, the first optical frequency comb is not modulated with data; and the first optical WDM signal is modulated with data.

According to another embodiment disclosed above in reference to FIGS. 1-3, provided is an optical-performance-monitoring method comprising: generating a first optical frequency comb (e.g., 252, FIG. 2) using a first optical-frequency-comb source (e.g., 240 and 250, FIG. 2), wherein the first optical frequency comb has a first tooth spacing; optically mixing the first optical frequency comb and a first optical WDM signal (e.g., 222, FIG. 2) in an optical signal combiner (e.g., 260, FIG. 2) to generate a first mixed optical signal (e.g., 262, FIG. 2), wherein nominal spacing between carrier frequencies of the first optical WDM signal is different from the first tooth spacing; and measuring one or more beat signals (e.g., 306₁-306₄, FIG. 3C) corresponding to the first mixed optical signal to determine one or more parameters of the first optical WDM signal, wherein each of said one or more beat signals has a respective beat frequency (e.g., b₁-b₄, FIG. 3C) corresponding to a frequency difference between a respective tooth from the first optical frequency comb and a respective spectral line of the first optical WDM signal.

In some embodiments of the above optical-performance-monitoring method, the step of generating comprises controllably changing polarization of the first optical frequency comb using a polarization modulator (e.g., 250, FIG. 2).

In some embodiments of any of the above optical-performance-monitoring methods, the step of measuring comprises: converting the first mixed optical signal into a corresponding electrical signal (e.g., 272, FIG. 2) using an optical-to-electrical converter (e.g., 270, FIG. 2); and applying a Fourier transform to said corresponding electrical signal to generate said one or more beat signals.

In some embodiments of any of the above optical-performance-monitoring methods, the method further comprises: in response to the determined one or more parameters of the first optical WDM signal, changing one or more operating parameters of a component (e.g., 120, 150, FIG. 1) of an optical system (e.g., 100), wherein the optical system includes the first optical-frequency-comb source, the optical signal combiner, and a signal-processing circuit (e.g., 270 and 280, FIG. 2) configured to measure the one or more beat signals.

In some embodiments of any of the above optical-performance-monitoring methods, at least one modulation sideband of the first optical WDM signal contains a spectral line offset from the carrier frequency and at least one of the said one or more beat signals has a beat frequency (e.g., similar to b₁-b₄, FIG. 3C) corresponding to a frequency difference between a respective tooth from the first optical frequency comb and said spectral line offset from the carrier frequency in the first optical WDM signal.

While this invention has been described with reference to illustrative embodiments, this description is not intended to be construed in a limiting sense.

As used in the claims, the term “WDM” should be construed to cover any of the following embodiments: (i) conventional WDM, (ii) DWDM, (iii) OFDM, and (iv) optical super-channel.

Various modifications of the described embodiments, as well as other embodiments of the invention, which are apparent to persons skilled in the art to which the invention pertains are deemed to lie within the principle and scope of the invention as expressed in the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The present inventions may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors” and “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

What is claimed is:

1. An apparatus comprising:
a first optical-frequency-comb source configured to generate a first optical frequency comb having a first tooth spacing;
a first optical signal combiner configured to optically mix the first optical frequency comb and a first optical WDM signal to generate a first mixed optical signal, wherein nominal spacing between carrier frequencies of the first optical WDM signal is different from the first tooth spacing; and
a first signal-processing circuit configured to measure one or more beat signals corresponding to the first mixed optical signal to determine one or more parameters of the first optical WDM signal, wherein each of said one or more beat signals has a respective beat frequency corresponding to a frequency difference between a respective tooth from the first optical frequency comb and a respective spectral line of the first optical WDM signal.

2. The apparatus of claim 1, wherein the respective spectral line is a spectral line representing a respective carrier frequency of the first optical WDM signal.

3. The apparatus of claim 1, wherein the respective spectral line is a spectral line in a modulation sideband of a respective carrier frequency of the first optical WDM signal.

4. The apparatus of claim 1, wherein the first optical WDM signal has been generated using a second optical frequency comb having a second tooth spacing different from the first tooth spacing.

5. The apparatus of claim 1, wherein the one or more parameters of the first optical WDM signal determined by the first signal processing circuit include one or more of:
optical power of an individual modulated or non-modulated optical carrier;
optical power per polarization of an individual modulated or non-modulated optical carrier; and
carrier frequency of an individual optical carrier.

6. The apparatus of claim 1, wherein the first optical-frequency-comb source comprises a polarization modulator configured to controllably change polarization of the first optical frequency comb.

7. The apparatus of claim 6, wherein the polarization modulator is configured to cause the polarization of the first optical frequency comb to alternate between a first polarization and a second polarization orthogonal to the first polarization.

8. The apparatus of claim 1, wherein the first optical signal combiner comprises a 90-degree optical hybrid.

9. The apparatus of claim 1, wherein the first signal-processing circuit comprises:
an optical-to-electrical converter configured to convert the first mixed optical signal into a corresponding electrical signal; and
a signal processor configured to transform said corresponding electrical signal to generate said one or more spectral components.

10. The apparatus of claim 9, wherein the optical-to-electrical converter is configured to operate as a low-pass filter.

11. The apparatus of claim 9, wherein the signal processor is configured to perform one or more of the following:
analog-to-digital conversion of the corresponding electrical signal;
Fourier transformation of a digital form of the corresponding electrical signal;
digital filtering of a digital form of the corresponding electrical signal; and
time averaging of a digital form of the corresponding electrical signal.

12. The apparatus of claim 1, further comprising an optical transmitter configured to generate the first optical WDM signal by modulating with data one or more teeth of a second optical frequency comb different from the first optical frequency comb.

13. The apparatus of claim 1, further comprising an optical transmitter configured to generate the first optical WDM signal by modulating with data a plurality of optical carriers generated by a corresponding plurality of lasers.

14. The apparatus of claim 1, further comprising a controller, wherein, in response to the one or more parameters of the first optical WDM signal determined by the first signal-processing circuit, the controller is configured to cause a component of the apparatus to change one or more of component's operating parameters.

15. The apparatus of claim 14, wherein:
the component is an optical-amplifier-based signal repeater; and
the one or more of the component's operating parameters comprises an optical gain therein.

16. The apparatus of claim 1, further comprising:
a second optical-frequency-comb source configured to generate a second optical frequency comb having a second tooth spacing different from the first tooth spacing and the nominal spacing between carrier frequencies of the first optical WDM signal;
a second optical signal combiner configured to optically mix the second optical frequency comb and a second optical WDM signal to generate a second mixed optical signal; and
a second signal-processing circuit configured to measure one or more beat signals corresponding to the second mixed optical signal to determine one or more parameters of the second optical WDM signal, wherein each of said one or more beat signals has a respective beat frequency corresponding to a frequency difference between a respective tooth from the second optical frequency comb and a respective spectral line of the second optical WDM signal.

17. The apparatus of claim 16, further comprising a controller, wherein, in response to the one or more parameters of the first optical WDM signal determined by the first signal-processing circuit and to the one or more parameters of the second optical WDM signal determined by the second signal-processing circuit, the controller is configured to cause (i) a first component of the apparatus to change one or more of first component's operating parameters and (ii) a second component of the apparatus to change one or more of second component's operating parameters.

18. The apparatus of claim 17, wherein:
the first component is an optical-amplifier-based signal repeater; and
the second component is a ROADM.

19. The apparatus of claim 1, wherein:
the first optical frequency comb is not modulated with data; and
the first optical WDM signal is modulated with data.

20. An optical-signal-monitoring method comprising:
generating a first optical frequency comb using a first optical-frequency-comb source, wherein the first optical frequency comb has a first tooth spacing;
optically mixing the first optical frequency comb and a first optical WDM signal in an optical signal combiner to generate a first mixed optical signal, wherein nominal spacing between carrier frequencies of the first optical WDM signal is different from the first tooth spacing; and
measuring one or more beat signals corresponding to the first mixed optical signal to determine one or more parameters of the first optical WDM signal, wherein each of said one or more beat signals has a respective beat frequency corresponding to a frequency difference between a respective tooth from the first optical frequency comb and a respective spectral line of the first optical WDM signal.
